(19) United States
(12) Patent Application Publication
(10) Pub. No.: US 2015/0006820 A1
(43) Pub. Date: Jan. 1, 2015

(54) DYNAMIC MANAGEMENT OF WRITE-MISS BUFFER TO REDUCE WRITE-MISS TRAFFIC

(71) Applicant: TEXAS INSTRUMENTS INCORPORATED, Dallas, TX (US)

(72) Inventors: Naveen Bhoria, Plano, TX (US); Joseph Raymond Michael Zbiciak, Farmers Branch, TX (US); Raguram Damodaran, Plano, TX (US); Abhijeet Ashok Chachad, Plano, TX (US)

(73) Assignee: TEXAS INSTRUMENTS INCORPORATED, Dallas, TX (US)

(21) Appl. No.: 13/973,306

(22) Filed: Aug. 22, 2013

Related U.S. Application Data
(60) Provisional application No. 61/840,927, filed on Jun. 28, 2013.

(51) Int. Cl. G06F 12/08

(52) U.S. Cl. CPC G06F 12/0811
USPC 711/122

(57) ABSTRACT

Traffic output from a cache write-miss buffer is controlled by determining whether a predetermined condition is satisfied, and outputting an oldest entry from the buffer only in response to a determination that the predetermined condition is satisfied. Posting of a new entry to the buffer is insufficient to satisfy the predetermined condition.

This Application claims priority from Provisional Application No. 61/840,927, filed Jun. 28, 2013.

### FIELD

The present work relates generally to multilevel cache control and, more particularly, to write-miss buffer control.

### BACKGROUND

In a multilevel cache hierarchy, a write command for which a cache miss occurs (a “write-miss”) is stored in a write-miss FIFO buffer so that the CPU need not stall and write-miss data can be forwarded to the next level of cache when possible. Conventional approaches to write-miss buffer management merge newly received write misses with write-miss entries already in the buffer, if the appropriate merge conditions obtain (e.g., address and permission matches). The write-miss buffer is typically drained fast enough (e.g., at the same rate at which new write-misses are being posted by the CPU) to prevent the CPU from stalling due to a full write-miss buffer. Entries that are output from the write-miss buffer are forwarded to the next level of the cache hierarchy.

In some situations, it is desirable to reduce the traffic from the write-miss buffer to the next level of cache. As one example, such traffic reduction becomes more important when write-through mode is enabled in the cache controller. Although the aforementioned conventional approaches adequately avoid complete filling of the write-miss buffer, they do not address reducing traffic from the write-miss buffer to the next cache level.

Is desirable in view of the foregoing to provide for write-miss buffer management that can reduce traffic to the next cache level.

### BRIEF DESCRIPTION OF THE DRAWINGS

FIGS. 1-3 conceptually illustrate examples of dynamic write-miss buffer control according to example embodiments of the present work.

FIG. 4 diagrammatically illustrates a data processing system according to example embodiments of the present work.

FIG. 5 diagrammatically illustrates the cache controller of FIG. 4 in more detail according to example embodiments of the present work.

FIG. 6 illustrates operations that may be performed according to example embodiments of the present work.

FIG. 7 illustrates operations that may be performed according to further example embodiments of the present work.

### DETAILED DESCRIPTION

The present work recognizes that traffic from the write-miss buffer to the next cache level may be reduced by measures that produce as many write-miss merges as possible. Example embodiments of the present work provide a dynamic scheme for write-miss buffer management wherein a posted write-miss command is retained in the write-miss buffer as long as possible without increasing CPU stall cycles. This increases the likelihood that entries in the write-miss buffer will be merged with future write-misses, thereby reducing traffic from the write-miss buffer to the next cache level without adversely increasing the incidence of CPU stalls.

Three parameters are available to control the drain rate of the write-miss FIFO buffer dynamically: (1) the number of write cycles that a particular write-miss has spent in the buffer; (2) the number of free entries (unused locations) available in the buffer; and (3) attributes of the write-miss, for example, not merge-able with another write-miss, time-sensitive, etc. In some embodiments, the write-miss buffer only outputs a write-miss entry if one of the following conditions obtains:

the oldest entry has been in the buffer for a number of write cycles that equals (or exceeds) a value “MAX”, where MAX is a number of cycles less than the maximum latency tolerable by the system; or

the number of entries in the buffer reaches (or exceeds) a threshold value; or

the buffer contains an entry having an attribute that indicates expedited handling is required for the entry, for example, an entry having a strict latency requirement, such as a time or delay sensitive entry, an entry that is not a cacheable write command, or an entry that is a special type of write command that must be committed to memory as soon as possible (e.g., a coherence write-flush command). Another example where an expedited handing attribute may be used is when there is a pending Read Miss that needs to go out in order.

In various embodiments, the value of MAX is specified by either the user or the application, and is tapered based on the number of free buffer entries available, for example, MAX=[# of specified cycles]*[# of free entries available]. Thus, MAX may be dynamically adjusted to vary in proportion to the number of unused locations currently available in the buffer. In some embodiments, MAX is set to a default value, for example, 1, or another value suitable for the application.

In various embodiments, the threshold value is specified by either the user or the application. In some embodiments, the threshold value is set to a default value, for example, ½ of the write-miss buffer size. Some embodiments dynamically adjust the threshold value based on the input stream pattern. For example, if hardware detects that newly received write-misses are being merged with existing buffer entries four locations ahead of them in the write-miss FIFO buffer, then the threshold value could be set higher than four.

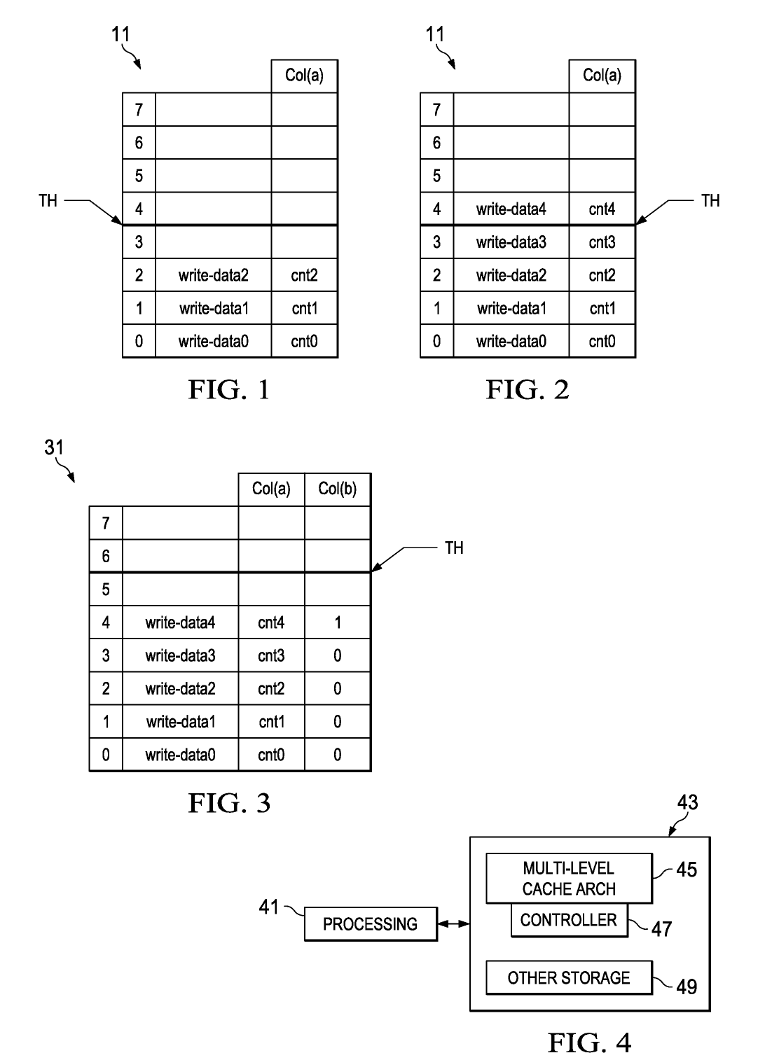

FIGS. 1-3 conceptually illustrate examples of dynamic write-miss buffer control according to example embodiments of the present work. Each example shows a FIFO buffer with eight locations, designated 0-7. FIG. 1 shows a buffer 11 with write-miss entries in locations 0-2, and FIG. 2 shows the buffer 11 with entries in locations 0-4. FIG. 3 shows a buffer 31 with write-miss entries in locations 0-4. In FIGS. 1-3, the buffer entries are designated as “write-data0”, “write-data1”, etc., and are shown oldest-to-newest from bottom-to-top. In the column designated Col(a) in FIGS. 1-3 are shown cycle counts (cnt0, cnt1, etc.) associated with the respective write-miss entries. The cycle count is initialized to 0 when the corresponding write-miss is posted to the buffer, and increments at each write cycle. In the column designated Col(b) in FIG. 3 are shown bits that indicate attributes associated with the respective write-miss entries. In the FIG. 3 example, a value of 1 in Col(b) tags the corresponding entry to indicate that it requires expedited handling due, for example, to reasons such as those described above.

The following discussion illustrates examples of the dynamic write-miss buffer control described above. Considering FIG. 1, the entry write-data0 is not output until the corresponding count, cnt0, reaches MAX. Considering FIG. 2, the entry write-data0 is output in response to the posting of the entry write-data4, and this occurs regardless of whether cnt0 has reached MAX, because the number of entries present in the buffer is five, which exceeds the threshold value (designated at TH in FIGS. 1-3), which is four in FIG. 2.

Considering FIG. 3, the entries will begin to drain from the buffer in response to the posting of the entry write-data4. This occurs regardless of whether cnt0 has reached MAX, and regardless of the fact that the number of entries present in buffer 31 is less than the threshold value TH, because write-data4 requires expedited handling (its Col(b) value is 1). When draining the FIFO buffer 31, write-data0 through write-data3 are successively output before outputting write-data4. Some embodiments respond instead to the posting of write-data4 by permitting the write-data4 entry to be advanced and become the next output from the buffer 31. (As will be recognized by workers in the art, such operation may require extra checking to ensure that data order and integrity are maintained.)

FIG. 4 diagrammatically illustrates a data processing system in which dynamic write-miss buffer control of the type described above may be implemented according to example embodiments of the present work. A data processing resource 41 is coupled to a memory storage resource 43. In various embodiments, the memory storage resource 43 may be wholly separate from data processing resource 41, or partially or fully integrated with data processing resource 41. The memory storage resource 43 includes multilevel cache architecture 45 and other storage 49. A cache controller 47 controls operation of the multilevel cache 45.

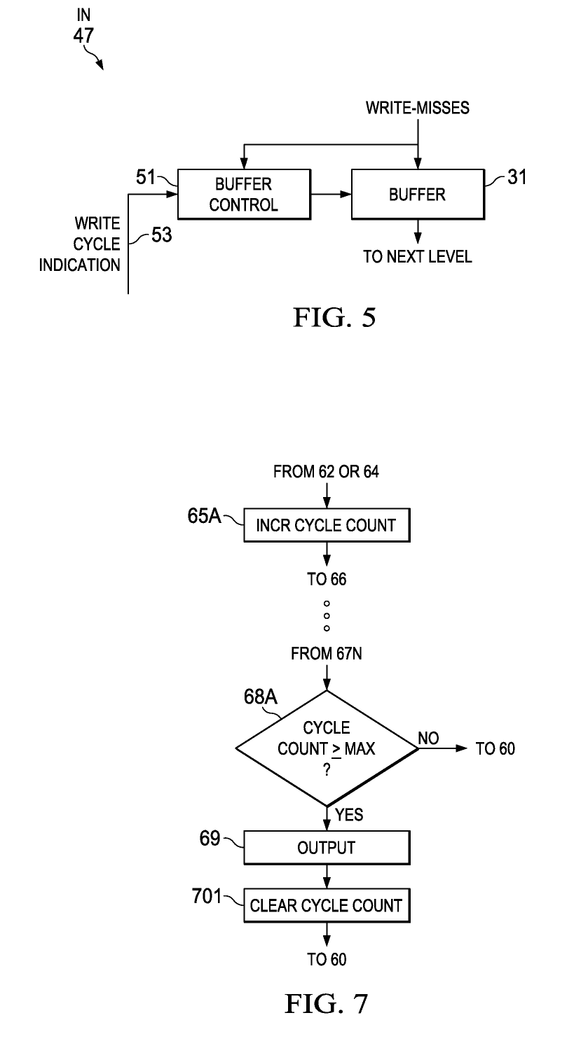

FIG. 5 diagrammatically illustrates the cache controller 47 of FIG. 4 in more detail according to example embodiments of the present work. In the illustrated example, FIFO buffer 31 of FIG. 3, for a particular level of the cache architecture 45, receives write-misses and forwards them to the next cache level under control of a buffer controller 51 that is coupled to the buffer 51 and receives the write-misses. The buffer controller 51 also receives at 53 an indication of each write cycle performed by the data processing resource 41 of FIG. 4. In some embodiments, the buffer controller 51 is capable of the type of dynamic write-miss buffer control described above.

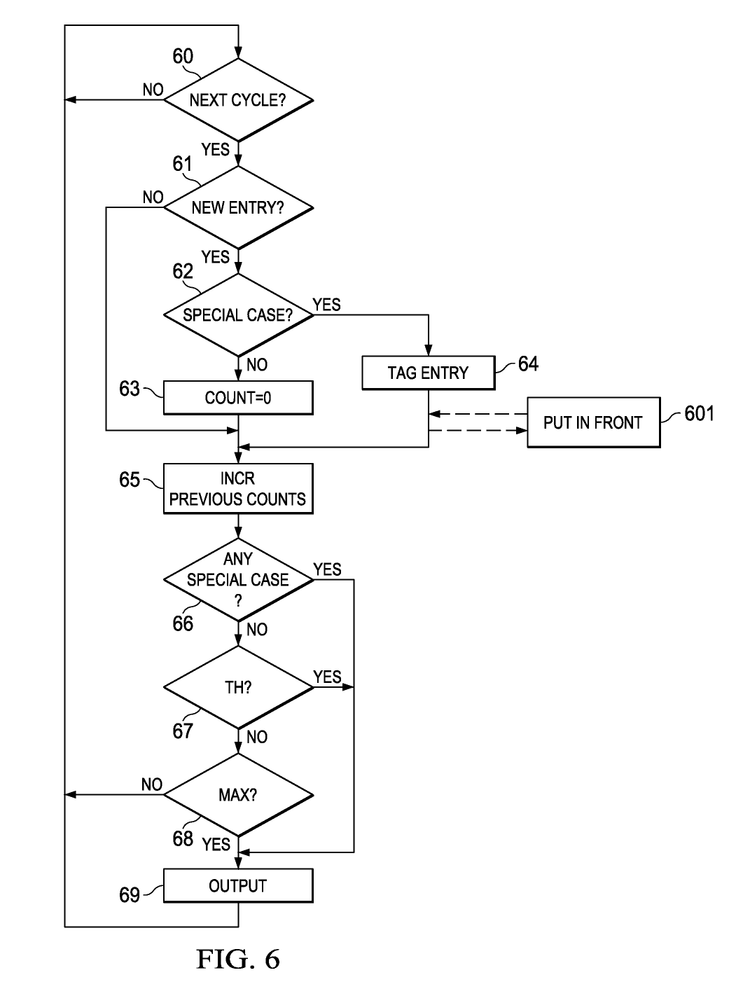

FIG. 6 illustrates operations that may be performed to implement the type of dynamic write-miss buffer control described above according to example embodiments of the present work. In some embodiments, the illustrated operations may be performed by the cache controller 47 of FIGS. 4 and 5. In FIG. 6, each write cycle (e.g., of the data processing resource 41 of FIG. 4) is detected at 60. When a write cycle is detected at 60, it is then determined at 61 whether a new write-miss entry is posted to the write-miss buffer. If not, operations proceed to 65 (described below). If a new entry is posted at 61, it is then determined at 62 whether the entry has an attribute of a special case (special handling) as described above. If not, the count value (see also cnt0, cnt1, etc. in FIG. 3) for the entry is initialized to 0, after which operations proceed to 65. Otherwise, the entry is tagged as a special handling case (see also the “1” bit at Col(b) in FIG. 3), and operations proceed to 65.

At 65, the previously existing count values of the previously posted entries are incremented. Thereafter, it is determined at 66 whether the buffer contains a special handling case entry. If so, the oldest entry is output at 69 for forwarding to the next cache level, after which the next write cycle is awaited at 60. Otherwise, it is determined at 67 whether the number of entries in the buffer has reached the threshold value. If so, operations proceed to 69, where the oldest entry is output. Otherwise, it is determined at 68 whether the number of write cycles that the oldest entry has spent in the buffer has reached MAX. If so, operations proceed to 69, where the oldest entry is output. Otherwise, the next write cycle is awaited at 60.

As described above, some embodiments permit a special handling case entry to be advanced and become the next output from the buffer. An example of such embodiments is illustrated by broken line at 601 in FIG. 6 where, after a special handling case entry is tagged at 64, it is put in front of the other buffer entries to be next output from the buffer.

Some embodiments reduce complexity by using only a single cycle count instead of using a different cycle count for each write-miss buffer entry. This single cycle count indicates how many write cycles have elapsed since an entry was last output from the write-miss buffer. Whenever an entry is output from the buffer, the cycle count is reset to 0. If this cycle count reaches the value of MAX, then the oldest entry is output and the cycle count is reset. An example of this is illustrated in FIG. 7 according to example embodiments of the present work.

The operations of FIG. 7 can be understood when considered in conjunction with operations of FIG. 6. Single cycle count operations are largely the same as the multiple cycle count operations described relative to FIG. 6, with the exception of the modifications now described. In single cycle count embodiments, operation 63 of FIG. 6 is omitted, and operation 65 of FIG. 6 is replaced by operation 65A shown in FIG. 7, wherein the single cycle count is incremented. As also shown in FIG. 7, operation 68 of FIG. 6 is replaced by operation 68A, where the single cycle count is compared to MAX. If the count has reached MAX at 68A, the oldest entry is output at 69. Otherwise, the next cycle is awaited at 60. The cycle count is cleared (reset to 0) at 701, in conjunction with the outputting at 69.

Although example embodiments of the present work have been described above in detail, this does not limit the scope of the work, which can be practiced in a variety of embodiments.

What is claimed is:

1. A method of controlling output traffic from a buffer that stores write-miss entries associated with one level of a cache for subsequent forwarding to another level of the cache, comprising:
determining whether a predetermined condition is satisfied; and
outputting an oldest entry from the buffer only in response to a determination that said predetermined condition is satisfied;
wherein posting of a new entry to the buffer is insufficient to satisfy said predetermined condition.

2. The method of claim 1, wherein said predetermined condition is satisfied if said oldest entry has been stored in the buffer for a predetermined number of write cycles.

3. The method of claim 2, wherein said predetermined number of write cycles is dynamically adjustable based on a number of unused locations available in the buffer.

4. The method of claim 2, wherein said predetermined condition is satisfied if an entry in the buffer requires expedited forwarding to said another level of cache.

5. The method of claim 4, wherein said predetermined condition is satisfied if the buffer contains a predetermined threshold number of entries.

6. The method of claim 1, wherein said predetermined condition is satisfied if a predetermined number of write cycles have occurred since an entry was last output from the buffer.

7. The method of claim 2, wherein said predetermined condition is satisfied if the buffer contains a predetermined threshold number of entries.

8. The method of claim 1, wherein said predetermined condition is satisfied if the buffer contains a predetermined threshold number of entries.

9. The method of claim 1, wherein said predetermined condition is satisfied if an entry in the buffer requires expedited forwarding to said another level of cache.

10. The method of claim 9, wherein said predetermined condition is satisfied if the buffer contains a predetermined threshold number of entries.

11. A cache controller apparatus, comprising:
a buffer configured to store write-miss entries associated with one level of a cache for subsequent forwarding to another level of the cache; and
a buffer controller coupled to said buffer and configured to determine whether a predetermined condition is satisfied, and to output an oldest entry from said buffer only in response to a determination that said predetermined condition is satisfied;
wherein posting of a new entry to said buffer is insufficient to satisfy said predetermined condition.

12. The apparatus of claim 11, wherein said predetermined condition is satisfied if said oldest entry has been stored in the buffer for a predetermined number of write cycles.

13. The apparatus of claim 12, wherein said predetermined condition is satisfied if an entry in the buffer requires expedited forwarding to said another level of cache.

14. The apparatus of claim 13, wherein said predetermined condition is satisfied if the buffer contains a predetermined threshold number of entries.

15. The apparatus of claim 12, wherein said predetermined condition is satisfied if the buffer contains a predetermined threshold number of entries.

16. The apparatus of claim 11, wherein said predetermined condition is satisfied if the buffer contains a predetermined threshold number of entries.

17. The apparatus of claim 11, wherein said predetermined condition is satisfied if an entry in the buffer requires expedited forwarding to said another level of cache.

18. The apparatus of claim 17, wherein said predetermined condition is satisfied if the buffer contains a predetermined threshold number of entries.

19. A data processing system, comprising:
a data processing resource; and
multilevel cache architecture coupled to said data processing resource, and having a cache controller that includes a buffer configured to store write-miss entries associated with one level of a cache for subsequent forwarding to another level of the cache;
wherein said cache controller includes a buffer controller coupled to said buffer and configured to determine whether a predetermined condition is satisfied, and to output an oldest entry from said buffer only in response to a determination that said predetermined condition is satisfied; and
wherein posting of a new entry to said buffer is insufficient to satisfy said predetermined condition.

20. An apparatus for controlling output traffic from a buffer that stores write-miss entries associated with one level of a cache for subsequent forwarding to another level of the cache, comprising:
means for determining whether a predetermined condition is satisfied; and
means for outputting an oldest entry from the buffer only in response to a determination that said predetermined condition is satisfied;
wherein posting of a new entry to the buffer is insufficient to satisfy said predetermined condition.
